(19) United States
(12) Patent Application Publication
(10) Pub. No.: US 2013/0286050 A1
(43) Pub. Date: Oct. 31, 2013

(54) CONTENT AUTO-FIT METHOD AND SYSTEM

(71) Applicants: William E. HERTLING, Portland, OR (US); Mike WHITMARSH, Vancouver, WA (US)

(72) Inventors: William E. HERTLING, Portland, OR (US); Mike WHITMARSH, Vancouver, WA (US)

(21) Appl. No.: 13/460,790

(22) Filed: Apr. 30, 2012

(51) Int. Cl. G09G 5/373

(52) U.S. Cl. 345/660

(57) ABSTRACT

In at least some examples, a method includes receiving, by a computing device, initial content to be rendered. The initial content includes a plurality of sections in a predetermined order. The method also includes applying auto-fit rules to the initial content, by the computing device, wherein the auto-fit rules include a prioritization for the plurality of sections and a layout space. If the initial content does not fit within the layout space, the method also includes updating content to be rendered, wherein the updated content omits at least one of the plurality of sections from the initial content based on the prioritization and maintains the predetermined order for non-omitted sections from the initial content.

### BACKGROUND

For content that is printed or rendered, there are many possible printout or rendering variations. Some of these printout or rendering variations are based on user preferences (e.g., font style and size), while other variations are based on paper size or display size/resolution. Still other printout or rendering variations are based on authorship or publisher preferences. Many existing printout or rendering variations limit side-to-side margins, but extend content from one page to another (or extend a scrollable page) to print or render all of the content. If space constraints for content to be printed or rendered are set (e.g., a page number limit or a scrollable page size limit) and the content exceeds these space constraints, elimination of some of the content is needed. The elimination of some of the content to be printed or rendered is not a trivial decision as it may affect the overall readability or desired organization of the content.

### BRIEF DESCRIPTION OF THE DRAWINGS

For a detailed description of illustrative examples of the disclosure, reference will now be made to the accompanying drawings in which:

FIG. 1 shows an example of a computer system in accordance with the disclosure;

FIG. 2 shows an example of a content auto-fit process in accordance with the disclosure;

FIG. 3 shows another example of a content auto-fit process in accordance with the disclosure;

FIG. 4 shows an example of a client device in accordance with the disclosure;

FIG. 5 shows an example of a server device in accordance with the disclosure;

FIG. 6 shows an example of various components of a computer system in accordance with the disclosure; and

FIG. 7 shows an example of a method in accordance with the disclosure.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to methods and systems for content auto-fit operations. In one example, the content auto-fit operations include receiving an initial content to be rendered, where the initial content comprises a plurality of sections in a predetermined order. The content auto-fit operations also may include applying content auto-fit rules to the initial content, where the content auto-fit rules comprise a prioritization for the plurality of sections and a layout space. If the initial content does not fit within the layout space, the content auto-fit operations may include determining updated content to be rendered, where the updated content omits at least one of the plurality of sections from the initial content based on the prioritization and maintains the predetermined order for non-omitted sections from the initial content. As an example, the content auto-fit operations may be performed by a computer device to prepare city guide information or website content (e.g., a news story), where the layout space is limited. In some examples, the disclosed content auto-fit operations are performed by a client device. Alternatively, the disclosed content auto-fit operations may be performed by a server device. Alternatively, some content auto-fit operations may be performed by a client device, while other content auto-fit operations are performed by a server device. As an example, a server device may determine the priority of content to be fitted to a layout space, while a client device may remove content prior to its rendering in accordance with the priority set by the server device.

The example content auto-fit methods and systems should not be interpreted, or otherwise used, as limiting the scope of the disclosure, including the claims. In addition, one skilled in the art will understand that the following description has broad application, and the discussion of any particular example is not intended to intimate that the scope of the disclosure, including the claims, is limited to that example.

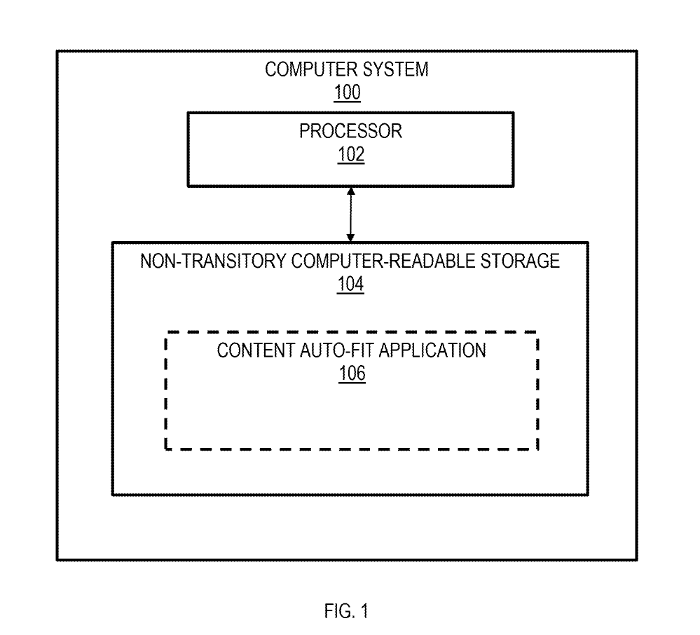

FIG. 1 shows an example of a computer system 100 in accordance with the disclosure. The computer system 100 may correspond to any of a variety of computing devices such as a desktop computer, a laptop computer, a smart phone, a tablet computer, a cellular phone, a personal digital assistant (PDA), a server computer, or a group of server computers. As shown, the computer system 100 comprises a processor 102 in communication with a non-transitory computer-readable storage 104, where processor 102 is configured to execute instructions read from the non-transitory computer readable storage 104. The processor 102 may be, for example, a general-purpose processor, a digital signal processor, or a microcontroller.

In some examples, the non-transitory computer readable storage 104 corresponds to random access memory (RAM), which stores programs and/or data structures during runtime of the computer system 100. For example, during runtime of the computer system 100, the non-transitory computer readable storage 104 may store the content auto-fit application 106 for execution by the processor 102 to perform the content auto-fit operations described herein.

Without limitation to other examples, the content auto-fit application 106, when executed, may cause the processor 102 to receive initial content to be rendered, where the initial content comprises a plurality of sections in a predetermined order. The content auto-fit application 106, when executed, also may cause the processor 102 to apply auto-fit rules to the initial content, where the auto-fit rules comprise a prioritization for the plurality of sections and a layout space. If the initial content does not fit within the layout space, the content auto-fit application 106, when executed, may cause the processor 102 to determine updated content to be rendered, where the updated content omits at least one of the plurality of sections from the initial content based on the prioritization and maintains the predetermined order for non-omitted sections from the initial content.

In some examples, the computer system 100 corresponds to a server computer that transmits the updated content to a client computer for rendering. Alternatively, the computer system 100 corresponds to a client computer that receives the initial content from a server computer and renders the updated content. The rendering of the updated content may be performed by a display (not shown) in communication with the processor 102, wherein the updated content is rendered on the display. Additionally or alternatively, the rendering of the updated content may be performed by a printer (not shown) in communication with the processor 102.

Without limitation to other examples, the initial content may comprise a city guide with sections of business or service information. At least some of the information in city guide may be organized in alphabetical order. As an example, the city guide may include organized information related to restaurants, shopping, bars/clubs, spas, and/or parks. The city guide also may include information related to legal services, financial services, beauty salon services, automotive services, construction/remodeling services, medical services, wholesale services, or other services. In alternative examples, the initial content comprises website content (e.g., a news story) with a plurality of paragraphs, where each paragraph is a separate section or is part of a section. In some examples, such as for the city guide and the website content examples, the sections may vary in length and the prioritization of the sections is independent of section length.

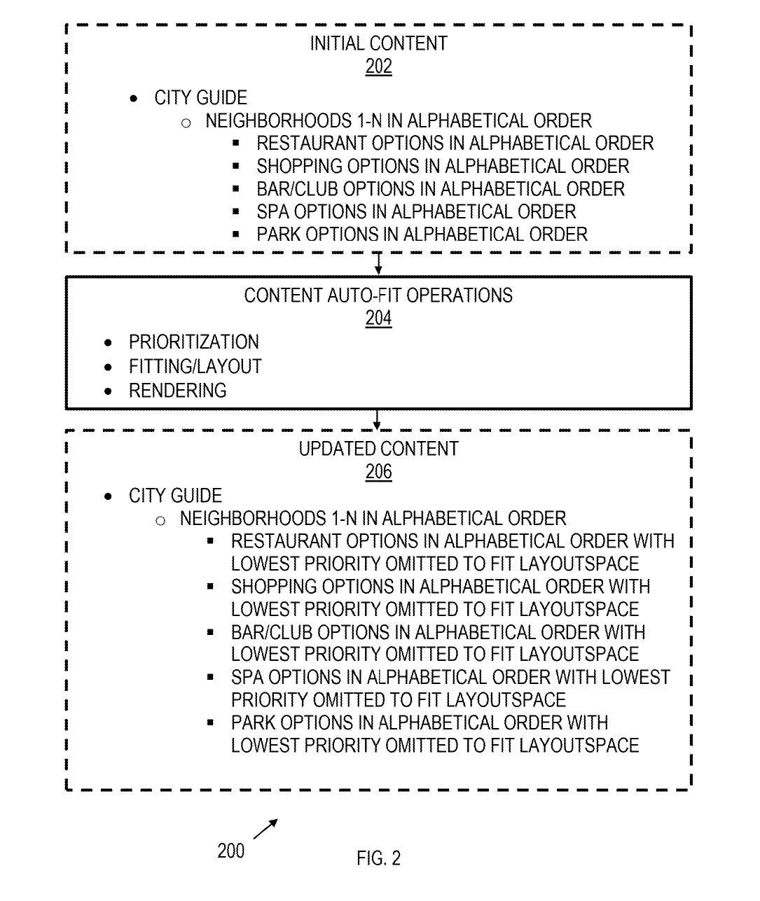

FIG. 2 shows an example of a content auto-fit process 200 in accordance with the disclosure. In the content auto-fit process 200 of FIG. 2, content auto-fit operations 204 are performed on initial content 202, whereby updated content 206 is determined. As shown, the initial content 202 may comprise a city guide organized as neighborhoods 1-N in alphabetical order. For each neighborhood, restaurant options, shopping options, bar/club options, spa options, and park options are listed in alphabetical order. The information listed for each neighborhood may be grouped (e.g., the restaurant options together in alphabetical order, the shopping options together in alphabetical order, the bar/club options together in alphabetical order, the spa options together in alphabetical order, and the park options together in alphabetical order) or may be mixed in another prearranged organization. The prearranged organization is independent of the prioritization of sections applied by the content auto-fit operations 204.

Besides applying prioritizations to sections of the initial content 202, the content auto-fit operations 204 also may include fitting/layout operations and rending operations as described herein. For the prioritization operations, a description of the initial content (or the initial content 202 itself) is received, where priorities 1-N are assigned to different sections 1-N of the initial content 202. The priorities may be based on criteria such as ratings, likes, dislikes, proximity, geographical location, cost, or other criteria. Further, the assignment of priorities by the content auto-fit operations 204 may be automated based on rules and/or may involve user input. The prioritization rules may be generic or may be customized for the type of content corresponding with the initial content 202.

The fitting/layout operations of the content auto-fit operations 204 create a test layout area that is the same size as the total available space limit specified for the initial content 202. Then, a layout for the initial content 202 on the test layout area is determined based on the order of priority assigned to sections of the initial content 202 during the prioritization operations. The lowest priority section that fits or may fit within the test layout area is noted.

During the rendering operations of the content auto-fit operations 204, the sections of the initial content 202 corresponding to the sections that fit within the test layout area are rendered. There may be some uncertainty between the estimation provided by the test layout area and the rendered layout. Accordingly, the rendering operations may enable some level of fine-tuning to be employed where the highest priority section that was to be omitted for the rendered content is added, or where the lowest priority section that was to be included for the rendered content is omitted.

As shown, the updated content 206 includes the city guide organized as neighborhoods 1-N in alphabetical order. In other words, the updated content 206 includes the same organization as the initial content 202. For each neighborhood, at least some restaurant options, shopping options, bar/club options, spa options, and/or park options are omitted, while the remaining options stay in the order they were in for the initial content 202 (e.g., alphabetical order). Again, the information listed for each neighborhood in the updated content may be grouped (e.g., the restaurant options together in alphabetical order, the shopping options together in alphabetical order, the bar/club options together in alphabetical order, the spa options together in alphabetical order, and the park options together in alphabetical order) or may be mixed in another prearranged organization. The prearranged organization is independent of the prioritization applied by the content auto-fit operations 204.

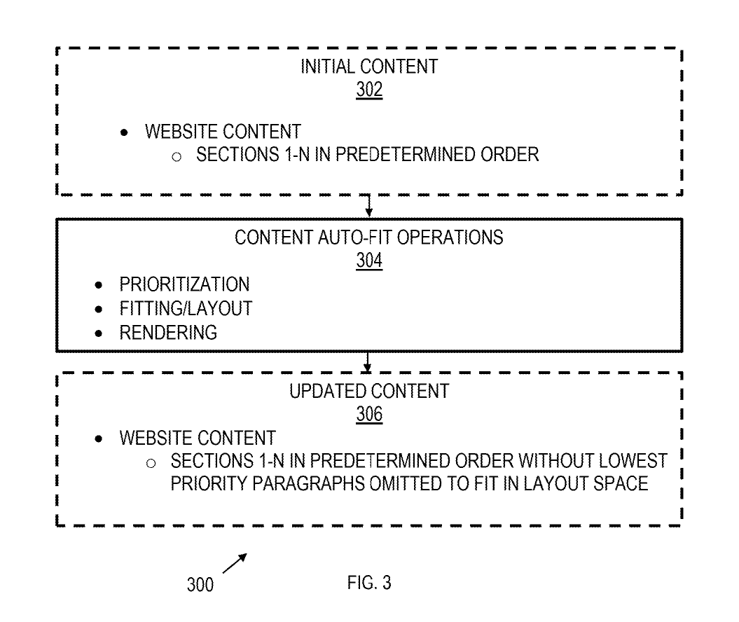

FIG. 3 shows another example of a content auto-fit process 300 in accordance with the disclosure. In the content auto-fit process 300, content auto-fit operations 304 are performed on initial content 302, whereby updated content 306 is determined. As shown, the initial content 302 may comprise website content organized as sections (e.g., paragraphs) 1-N in a predetermined order. The sections of the initial content 302 may be organized based on authorship or publisher input and is independent of the prioritization applied by the content auto-fit operations 304.

Besides applying prioritizations to sections of the initial content 302, the content auto-fit operations 304 also may include fitting/layout operations and rending operations as described herein. For the prioritization operations, a description of the initial content (or the initial content 302 itself) is received, where priorities 1-N are assigned to the different sections 1-N of the initial content 302. The priorities may be based on criteria such as themes, duplicity, ratings, likes, dislikes, geographical location, or other criteria. Further, the assignment of priorities by the content auto-fit operations 304 may be automated based on rules and/or may involve user input. The prioritization rules may be generic or may be customized for the type of content corresponding with the initial content 302.

The fitting/layout operations of the content auto-fit operations 304 create a test layout area that is the same size as the total available space limit specified for the initial content 302. Then, a layout for the initial content 302 on the test layout area is determined based on the order of priority assigned to sections of the initial content 302 during the prioritization operations. The lowest priority section that fits or may fit within the test layout area is noted.

During the rendering operations of the content auto-fit operations 304, the sections of the initial content 302 corresponding to the sections that fit within the test layout area are rendered. There may be some uncertainty between the estimation provided by the test layout area and the rendered layout. Accordingly, the rendering operations may enable some level of fine-tuning to be employed where the highest priority section that was to be omitted for the rendered content is added, or where the lowest priority section that was to be included for the rendered content is omitted.

As shown, the updated content 306 includes the website content organized as sections 1-N, where the lowest priority sections are omitted so that the remaining sections fit within the layout space. The prearranged organization of the initial content 302 is independent of the prioritization applied by the content auto-fit operations 304, and thus the remaining sections in the updated content 306 have the same prearranged organization as the initial content 302 except for the omitted sections.

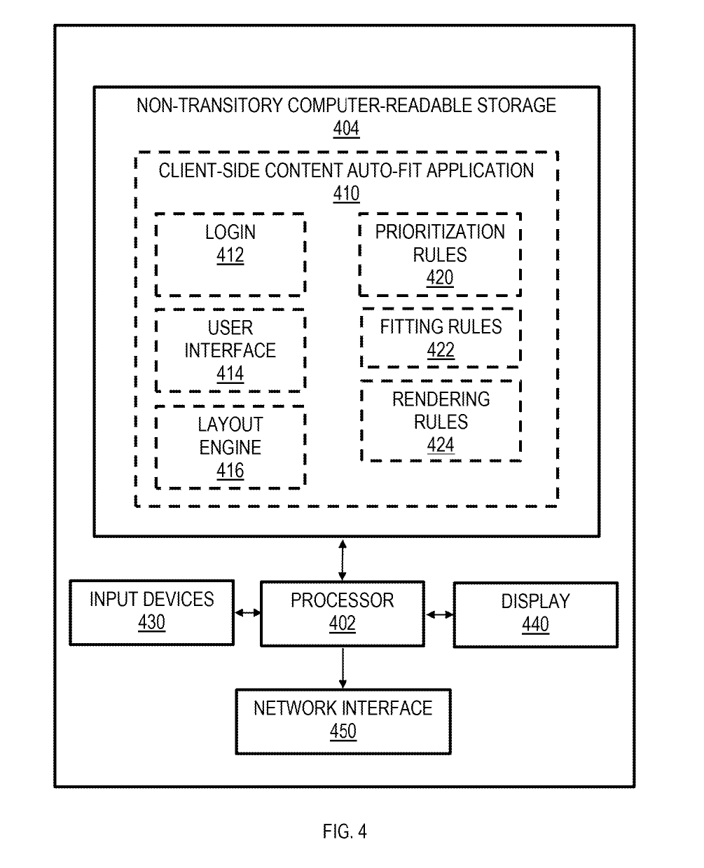

FIG. 4 shows an example of a client device 400 in accordance with the disclosure. As shown, the client device 400 comprises a processor 402 coupled to a non-transitory computer readable storage 404 storing a client-side content auto-fit application 410. The client device 400 also comprises input devices 430, a display 440, and a network interface 450 coupled to the processor 402.

The client device 400 is representative of a desktop computer, a smartphone, a cellular phone, a personal digital assistant (PDA), a tablet computer, a laptop computer, or other mobile device configured to communicate with a server computer or a server computer cluster for content auto-fit services. The processor 402 is configured to execute instructions read from the non-transitory computer readable storage 404. The processor 402 may be, for example, a general-purpose processor, a digital signal processor, a microcontroller, etc. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems.

In some examples, the non-transitory computer readable storage 404 corresponds to random access memory (RAM), which stores programs and/or data structures during runtime of the client device 400. For example, during runtime of the client device 400, the non-transitory computer readable storage 404 may store the client-side content auto-fit application 410 for execution by the processor 402 to perform the content auto-fit operations described herein. The client-side content auto-fit application 410 may be distributed to the client device 400 via a network connection or via a local storage device corresponding to any combination of non-volatile memories such as semiconductor memory (e.g., flash memory), magnetic storage (e.g., a hard drive, tape drive, etc.), optical storage (e.g., compact disc or digital versatile disc), etc. Regardless the manner in which the client-side telephony application 410 is distributed to the client device 400, the code and/or data structures corresponding to the client-side content auto-fit application 410 are loaded into the non-transitory computer readable storage 404 for execution by the processor 402.

The input devices 430 may comprise various types of input devices for selection of data or for inputting of data to the client device 400. As an example, the input devices 430 may correspond to a touch screen, a key pad, a keyboard, a cursor controller, a mouse, or other input devices.

The network interface 450 may couple to the processor 402 to enable the processor 402 to communicate with a server or server cluster. For example, the network interface 450 may enable the client device 400 to receive content auto-fit services and/or to update content auto-fit service options. In different embodiments, the network interface 450 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. The network interface 450 may enable the processor 402 to communicate with the Internet or one or more intranets. With such a network connection, it is contemplated that the processor 402 might receive information from the network, or might output information to the network in the course of performing the call transfer features described herein. Such information, which is often represented as a sequence of instructions to be executed using processor 402, may be received from and outputted to the network, for example, in the form of a computer data signal embodied in a carrier wave.

Such information, which may include data or instructions to be executed using processor 402 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well known to one skilled in the art. The baseband signal and/or signal embedded in the carrier wave may be referred to in some contexts as a transitory signal.

The processor 402 executes instructions, codes, computer programs, scripts which it accesses from hard disk, floppy disk, optical disk (these various disk based systems may all be considered secondary storage), read-only memory (ROM) , random access memory (RAM) , the network interface 450, or the input devices 430. While only one processor 402 is shown, multiple processors may be present. Thus, while instructions may be discussed as executed by a processor, the instructions may be executed simultaneously, serially, or otherwise executed by one or multiple processors.

In accordance with at least some examples, the client-side content auto-fit application 410 comprises a login module 412, a user interface module 414, a layout engine 416, prioritization rules 420, fitting rules 422, and rendering rules 424 to support the content auto-fit operations described herein. The login module 412 enables a user of the client device 400 to log into a content auto-fit service corresponding to a communication session established with the cloud-based server or server cluster. After a successful login, a user interface is presented on the client device 400 based on instructions and formatting data in the user interface module 414. In some examples, the login module 412 and session-based content auto-fit operations are omitted (i.e., public content auto-fit operations without a session are available).

The user interface module 414 may provide a user interface that enables the user of the client device 400 to make content auto-fit requests and/or to receive updated content based on the content auto-fit operations described herein. The user interface module 414 also may enable a user to select options for content auto-fit services such as options for the prioritization rules 420, for the fitting rules 422, or for the rendering rules 424.

The prioritization rules 420 apply a set of rules to prioritize sections of initial content. The prioritization rules 420 may be predetermined for a type of content or may be provided with the initial content (e.g., as metadata). Meanwhile, the layout engine 416 operates in accordance with the fitting rules 422 to test whether initial content fits within a test layout area and to identify the lowest priority section that is able to fit within the test layout area. The layout engine 416 also operates in accordance with the rendering rules 424 to render content within a rendered layout area up to the lowest priority section that is able to fit within the rendered layout area. The rendering rules 424 may be predetermined for a type of content or may be provided with the initial content (e.g., as metadata).

In some examples, the client device 400 receives updated content auto-fit information or rules from a server or server cluster. Such updates may have been previously submitted to the server or server cluster by a user or administrator. Additionally or alternatively, the server or server cluster may analyze websites or device-specific information to obtain updated information for improving content auto-fit services available to the client-side content auto-fit application 410.

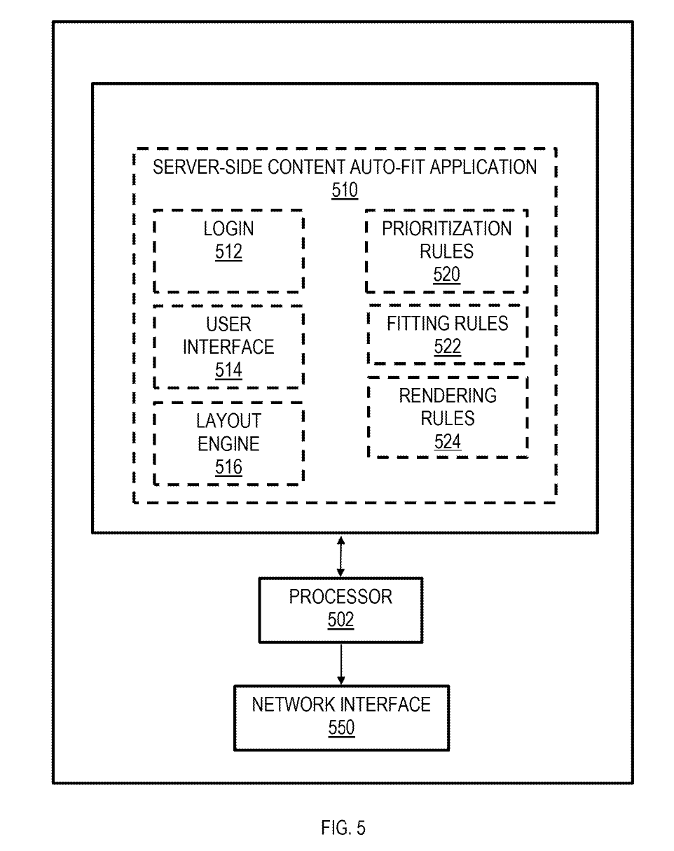

FIG. 5 shows an example of a server device 500 in accordance with the disclosure. The server device 500 may correspond to a cloud-based server or may be part of a server cluster to provide the content auto-fit services described herein. As shown, the server device 500 comprises a processor 502 and a non-transitory computer-readable storage 504 that stores a server-side content auto-fit application 510. The processor 502 also couples to a network interface 550 that enables network communications as described herein. In accordance with at least some embodiments, the server-side content auto-fit application 510 comprises a login module 512, a user interface module 514, a layout engine 516, prioritization rules 52, fitting rules 522, and rendering rules 524.

The login module 512 enables a user of a client device (e.g., client device 400) to log into a content auto-fit service corresponding to a communication session established with the server device 500. In some examples, the login module 512 and session-based content auto-fit operations are omitted (i.e., public content auto-fit operations without a session are available).

The user interface module 514 stores instructions and/or data to enable server-side operations that are compatible with user interface options available on a client-side content auto-fit application. In some examples, the content auto-fit operations or rules stored by the server device 500 or the client device 400 may be updated. Accordingly, a client-server synchronization may be performed to ensure the server-side content auto-fit application 510 executes on the server device 500 and the client-side content auto-fit application 410 executes on the client device 400 according to data/rule updates received from a user or administrator. Such updates may have been previously submitted to the server device 500 by a user or administrator via an update device or service and are implemented via the login process or a separate synchronization process. Additionally or alternatively, the server device 500 may have analyzed websites for updated content or may otherwise obtain updated information relevant to content auto-fit operations.

After a successful login, the server device 500 supports content auto-fit services using the layout engine 516, the prioritization rules 520, the fitting rules 522, and/or the rendering rules 524. The prioritization rules 520 apply a set of rules to prioritize sections of initial content. The prioritization rules 520 may be predetermined for a type of content or may be provided with the initial content (e.g., as metadata). Meanwhile, the layout engine 516 operates in accordance with the fitting rules 522 to test whether initial content fits within a test layout area and to identify the lowest priority section that is able to fit within the test layout area. The layout engine 516 also operates in accordance with the rendering rules 524 to render content within a rendered layout area up to the lowest priority section that is able to fit within the rendered layout area. The rendering rules 524 may be predetermined for a type of content or may be provided with the initial content (e.g., as metadata). In some examples, the server device 500 receives updated content auto-fit information or rules from a client device (e.g., the client device). For example, a client device may transmit user preferences or priorities relevant to content auto-fit operations. Additionally, a client device may transmit layout space preferences to the server device 500 to enable the server device 500 to return updated content that is suitable to the client device that submitted the request.

In FIGS. 4 and 5, the client device 400 and the server device 500 are both shown to perform various content auto-fit operations. Without limitation to other examples, it should be understood that some of the content auto-fit operations may be performed by the server device 500, while other content auto-fit operations 400 are performed by the client device 400. Further, it should be understood that communications between the client device 400 and the server device 500 related to content auto-fit operations may be asynchronous or continuous.

In some examples, content auto-fit operations are spread across at least two computers. Without limitation to other examples, a first server may establish the prioritization rules and determines a first content auto-fit estimate based on fitting rules and rendering rules as described herein. Subsequently, a second server uses the prioritization established by the first server to determine a second content auto-fit estimate, and to perform the final rendering operation. The above example is similar to a client/server scenario, where the server is a web server, and the client is a web browser, mobile browser, or mobile application, except that the relationship is between two servers.

In another example, instead of receiving the prioritization metadata ahead of time, the prioritization is dynamically determined by an algorithm executed either by a client computer that performs content auto-fit operations, or by a server computer that performs content auto-fit operations. The dynamic prioritization may, for example, be determined based on a distance from the average geographical location of a cluster of businesses, services, or points of interest. As particular entities are included in the cluster or excluded from the cluster, the geographical center changes, and so the distance of featured points of interest, business, or services from the center of the cluster is determined dynamically or at a particular time, and thus accurate metadata is not available ahead of time.

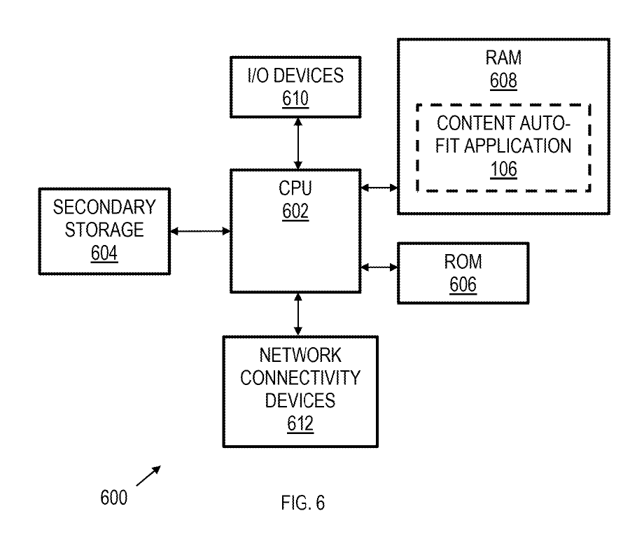

FIG. 6 shows an example of various components of a computer system 600 in accordance with the disclosure. The computer system 600 may perform various operations to support the content auto-fit operations described herein. The computer system 600 may correspond to part of the client device 400 or the server device 500 described herein.

As shown, the computer system 600 includes a processor 602 (which may be referred to as a central processor unit or CPU) that is in communication with memory devices including secondary storage 604, read only memory (ROM) 606, random access memory (RAM) 608, input/output (I/O) devices 610, and network connectivity devices 612. The processor 602 may be implemented as one or more CPU chips.

It is understood that by programming and/or loading executable instructions onto the computer system 600, at least one of the CPU 602, the RAM 608, and the ROM 606 are changed, transforming the computer system 600 in part into a particular machine or apparatus having the novel functionality taught by the present disclosure. In the electrical engineering and software engineering arts that functionality that can be implemented by loading executable software into a computer can be converted to a hardware implementation by well-known design rules. Decisions between implementing a concept in software versus hardware may hinge on considerations of stability of the design and numbers of units to be produced rather than any issues involved in translating from the software domain to the hardware domain. For example, a design that is still subject to frequent change may be implemented in software, because re-spinning a hardware implementation is more expensive than re-spinning a software design. Meanwhile, a design that is stable that will be produced in large volume may be preferred to be implemented in hardware, for example in an application specific integrated circuit (ASIC), because for large production runs the hardware implementation may be less expensive than the software implementation. Thus, a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

The secondary storage 604 is typically comprised of one or more disk drives or tape drives and is used for non-volatile storage of data and as an over-flow data storage device if RAM 608 is not large enough to hold all working data. Secondary storage 604 may be used to store programs which are loaded into RAM 608 when such programs are selected for execution. The ROM 606 is used to store instructions and perhaps data which are read during program execution. ROM 606 is a non-volatile memory device which typically has a small memory capacity relative to the larger memory capacity of secondary storage 604. The RAM 608 is used to store volatile data and perhaps to store instructions. Access to both ROM 606 and RAM 608 is typically faster than to secondary storage 604. The secondary storage 604, the RAM 608, and/or the ROM 606 may be referred to in some contexts as computer readable storage media and/or non-transitory computer readable media.

I/O devices 610 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 612 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. These network connectivity devices 612 may enable the processor 602 to communicate with the Internet or one or more intranets. With such a network connection, it is contemplated that the processor 602 might receive information from the network, or might output information to the network in the course of performing the above-described method steps. Such information, which is often represented as a sequence of instructions to be executed using processor 602, may be received from and outputted to the network, for example, in the form of a computer data signal embodied in a carrier wave.

Such information, which may include data or instructions to be executed using processor 602 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well known to one skilled in the art. The baseband signal and/or signal embedded in the carrier wave may be referred to in some contexts as a transitory signal.

The processor 602 executes instructions, codes, computer programs, scripts which it accesses from hard disk, floppy disk, optical disk (these various disk based systems may all be considered secondary storage 604), ROM 606, RAM 608, or the network connectivity devices 612. While only one processor 602 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 604, for example, hard drives, floppy disks, optical disks, and/or other device, the ROM 606, and/or the RAM 608 may be referred to in some contexts as non-transitory instructions and/or non-transitory information.

In an embodiment, the computer system 600 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 600 to provide the functionality of a number of servers that is not directly bound to the number of computers in the computer system 600. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the content auto-fit functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 600, at least portions of the contents of the computer program product to the secondary storage 604, to the ROM 606, to the RAM 608, and/or to other non-volatile memory and volatile memory of the computer system 600. The processor 602 may process the executable instructions and/or data structures in part by directly accessing the computer program product, for example by reading from a CD-ROM disk inserted into a disk drive peripheral of the computer system 600. Alternatively, the processor 602 may process the executable instructions and/or data structures by remotely accessing the computer program product, for example by downloading the executable instructions and/or data structures from a remote server through the network connectivity devices 612. The computer program product may comprise instructions that promote the loading and/or copying of data, data structures, files, and/or executable instructions to the secondary storage 604, to the ROM 606, to the RAM 608, and/or to other non-volatile memory and volatile memory of the computer system 600.

In some contexts, the secondary storage 604, the ROM 606, and the RAM 608 may be referred to as a non-transitory computer readable medium or a computer readable storage media. A dynamic RAM embodiment of the RAM 608, likewise, may be referred to as a non-transitory computer readable medium in that while the dynamic RAM receives electrical power and is operated in accordance with its design, for example during a period of time during which the computer 600 is turned on and operational, the dynamic RAM stores information that is written to it. Similarly, the processor 602 may comprise an internal RAM, an internal ROM, a cache memory, and/or other internal non-transitory storage blocks, sections, or components that may be referred to in some contexts as non-transitory computer readable media or computer readable storage media.

Such a non-transitory computer-readable storage medium may store the content auto-fit application 106 that, when executed, cause the processor 602 to receive initial content to be rendered, where the initial content comprises a plurality of sections in a predetermined order. The content auto-fit application 106, when executed, also may cause the processor 602 to apply auto-fit rules to the initial content, where the auto-fit rules comprise a prioritization for the plurality of sections and a layout space. The content auto-fit application 106, when executed, also may cause the processor 602 to determine if the initial content does not fit within the layout space. If the initial content does not fit within the layout space, the content auto-fit application 106, when executed, also may cause the processor 602 to determine updated content to be rendered, where the updated content omits at least one of the plurality of sections from the initial content based on the prioritization and maintains the predetermined order for non-omitted sections from the initial content.

In some examples, the content auto-fit application 106, when executed, may further cause the processor 602 to render the updated content on a local display, where the layout space is based on a size and resolution of the local display. The content auto-fit application 106, when executed, may further cause the processor 602 to transmit the updated content to a client computer for rendering, wherein the layout space is based on a display size of the client computer. The content auto-fit application 106, when executed, may cause the processor 602 to perform other content auto-fit operations as described herein.

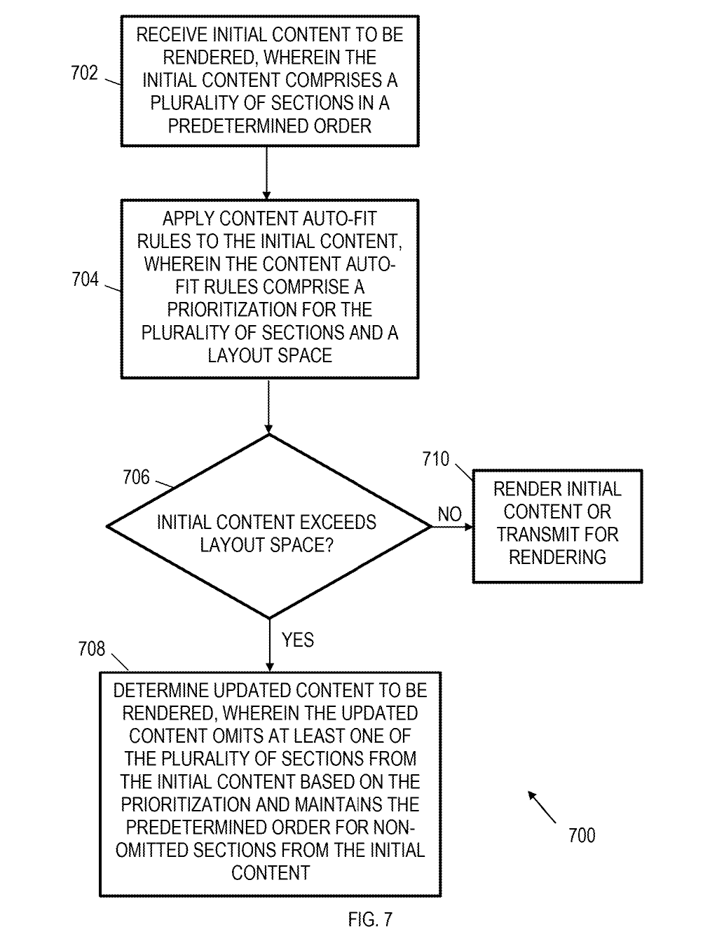

FIG. 7 shows an example of a method 700 in accordance with the disclosure. The method 700 may be performed by a computing device such as the computer system 100 of FIG. 1, the client device 400 of FIG. 4, or the server device 500 of FIG. 5. As shown, the method 700 comprises receiving initial content to be rendered, wherein the initial content comprises a plurality of sections in a predetermined order (block 702). At block 704, content auto-fit rules are applied to the initial content, wherein the content auto-fit rules comprise a prioritization for the plurality of sections and a layout space. If the initial content exceeds the layout space (determination block 706), the method 700 comprises determining updated content to be rendered at block 708, wherein the updated content omits at least one of the plurality of sections from the initial content based on the prioritization and maintains the predetermined order for non-omitted sections from the initial content. If the initial content does not exceed the layout space (determination block 706), the method 700 may render the initial content or transmit the initial content for rendering without modification or abbreviation (block 710).

In some examples, the method 700 may comprise additional or alternative steps. As an example, the method 700 may additionally comprise receiving information to customize the content-auto fit rules from a client computer, and returning the updated content to the client computer. Further, the method 700 may comprise storing different sets of content auto-fit rules corresponding to different types of initial content, identifying a type of initial content that is received, and selecting one of the different sets of content auto-fit rules for application to the received initial content based on the identified type of initial content. Further, the method 700 may comprise transmitting the updated content to a client computer for rendering, wherein the updated content is customized for a display of the client computer. Further, the method 700 may comprise rendering the updated content on a display in communication with the processor, wherein the layout space is based on a size or resolution of the display. Further, the method 700 may comprise receiving metadata indicating the prioritization for the plurality of sections within the initial content. Further, the method 700 may comprise determining the prioritization for the plurality of sections based on ratings associated with the plurality of sections or based on user preferences received with a request to render the initial content. Further, the method 700 may comprise receiving information defining the layout space, wherein the information is associated with a print space limitation or a display space limitation. Further, the method 700 may comprise determining information defining the layout space, wherein the information is associated with a print space limitation or a display space limitation. Further, the method 700 may comprise performing other content auto-fit operations as described herein.

While several examples have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method, comprising:
receiving, by a computing device, initial content to be rendered, wherein the initial content comprises a plurality of sections in a predetermined order;
applying content auto-fit rules to the initial content, by the computing device, wherein the content auto-fit rules comprise a prioritization for the plurality of sections and a layout space; and
if the initial content does not fit within the layout space, determining, by the computing device, updated content to be rendered, wherein the updated content omits at least one of the plurality of sections from the initial content based on the prioritization and maintains the predetermined order for non-omitted sections from the initial content.

2. The method of claim 1, further comprising receiving, by the computing device, information to customize the content-auto fit rules from a client computer, and returning the updated content to the client computer.

3. The method of claim 1, further comprising storing different sets of content auto-fit rules corresponding to different types of initial content, identifying a type of initial content that is received, and selecting one of the different sets of content auto-fit rules for application to the received initial content based on the identified type of initial content.

4. The method of claim 1, further comprising transmitting the updated content to a client computer for rendering, wherein the updated content is customized for a display of the client computer.

5. The method of claim 1, further comprising rendering the updated content on a display in communication with the processor, wherein the layout space is based on a size or resolution of the display.

6. The method of claim 1, further comprising receiving metadata indicating the prioritization for the plurality of sections with the initial content.

7. The method of claim 1, further comprising determining the prioritization for the plurality of sections based on ratings associated with the plurality of sections or based on user preferences received with a request to render the initial content.

8. The method of claim 1, further comprising receiving information defining the layout space, wherein the information is associated with a print space limitation or a display space limitation.

9. The method of claim 1, further comprising determining information defining the layout space, wherein the information is associated with a print space limitation or a display space limitation.

10. A computer system, comprising:
a processor; and
a non-transitory computer-readable storage coupled to the processor and storing a content auto-fit application that, when executed, causes the processor to:
receive initial content to be rendered, wherein the initial content comprises a plurality of sections in a predetermined order;
apply auto-fit rules to the initial content, wherein the auto-fit rules comprise a prioritization for the plurality of sections and a layout space; and
if the initial content does not fit within the layout space, determine updated content to be rendered, wherein the updated content omits at least one of the plurality of sections from the initial content based on the prioritization and maintains the predetermined order for non-omitted sections from the initial content.

11. The computer system of claim 10, wherein the computer system comprises a server computer that transmits the updated content to a client computer for rendering.

12. The computer system of claim 10, wherein the computer system comprises a client computer that receives the initial content from a server computer and renders the updated content.

13. The computer system of claim 10, further comprising a display in communication with the processor, wherein the updated content is rendered on the display.

14. The computer system of claim 10, further comprising a printer in communication with the processor, wherein the updated content is rendered by the printer.

15. The computer system of claim 10, wherein the initial content comprises a city guide, wherein the sections comprise business or service information, and wherein the predetermined order comprises an alphabetical order.

16. The computer system of claim 10, wherein the initial content comprises a news story, and wherein the sections comprise paragraphs of the news story.

17. The computer system of claim 10, wherein the sections vary in length, and wherein the prioritization is independent of section length.

18. A non-transitory computer-readable storage medium storing content auto-fit instructions that, when executed, cause a processor to:
receive initial content to be rendered, wherein the initial content comprises a plurality of sections in a predetermined order;
apply auto-fit rules to the initial content, wherein the auto-fit rules comprise a prioritization for the plurality of sections and a layout space; and
if the initial content does not fit within the layout space, determine updated content to be rendered, wherein the updated content omits at least one of the plurality of sections from the initial content based on the prioritization and maintains the predetermined order for non-omitted sections from the initial content.

19. The non-transitory computer-readable storage medium of claim 18, wherein the content auto-fit instructions, when executed, further cause the processor to render the updated content on a local display, wherein the layout space is based on a size and resolution of the local display.

20. The non-transitory computer-readable storage medium of claim 18, wherein the content auto-fit instructions, when executed, further cause the processor to transmit the updated content to a client computer for rendering, wherein the layout space is based on a display size of the client computer.
